(19) United States
(12) Patent Application Publication
(10) Pub. No.: US 2016/0133222 A1
(43) Pub. Date: May 12, 2016

(54) GLASS BOOK

(71) Applicant: Dana W. Paxson, Rochester, NY (US)

(72) Inventor: Dana W. Paxson, Rochester, NY (US)

(21) Appl. No.: 14/933,895

(22) Filed: Nov. 5, 2015

Related U.S. Application Data
(60) Provisional application No. 62/078,314, filed on Nov. 11, 2014.

(51) Int. Cl. G09G 5/00; G06F 3/041

(52) U.S. Cl. CPC G09G 5/003; G06F 3/0412; G09G 2360/144; G09G 2330/04; G09G 2320/0626

(57) ABSTRACT

A glass book is a sealed stack of layers of durable, amorphous embedding material, such as glass or a glass-like material, that strongly resists deterioration over millennium-long time scales. Embedded in the layers are components of silicon and other insulating, semiconductive, and conductive elements and combinations of elements likewise durable. Among these components are energy-capturing and energy-converting power cells to provide electrical energy, charge-storage cells to store power-cell energy and issue electrical power for the book's operation, computer microcircuits, and a durable, large-capacity, static, read-only, permanent memory subsystem. The permanent memory subsystem contains in digital form the texts, images, and other readable or user-presentable material for reading. Capacitance coupling, piezoelectric pressure coupling, or other means of tactile engagement through the surface layer enables a user to present touch commands to the book's circuitry to activate and alter the contents of its display for reading from the book's contents.

### CROSS-REFERENCE TO RELATED APPLICATION

This application claims the benefit of Provisional Application No. 62/078,314, filed Nov. 11, 2014, the disclosure of which is hereby incorporated by reference herein.

### BACKGROUND

The world of publishing, including the publishing of text, images, and other presentations for human perception and cognition, has been revolutionized by electronics. To summarize the transformations now still in progress would be impossible, but overall we've seen the printed, bound set of pages we call a book become an invisible, mutable image on a screen, connected to a nearly-infinite entity that is bound only into the limits of its reader's capacity and endurance.

This change raises important questions, among them this: What is the fate of a permanent piece of literature or other published work? Do such works vanish into the digital storm, swallowed by technological obsolescence, never to reappear? Our whole evolution of civilization has depended on its memory as recorded in its publications; what will become of civilization if our memories of vital knowledge and wisdom do not prolong their useful lives in permanent forms for our descendants?

Projects like The Long Now address issues of this sort. The very symbol of The Long Now—the symbol X—stands for 10,000 in Roman numerals, signifying ten thousand years as a useful, vital framework for planning, preservation, and continuation of our human world into the future. Such a long view must be underpinned by an infrastructure of memory, and our books, reinvented into all their most-durable and most-potent forms, will provide that memory.

But current technologies haven't reached that stage of permanence yet. Even the most durable of books in their oldest known forms lack the kind of demonstrable durability for a ten-thousand-year lifetime. Also, those most durable of books, whether chiseled in stone, baked into ceramic tablets, rolled up in parchments, or printed in chemically-preserved paper sheets bound together, lose meaning as the inevitable entropy of cultures washes over them with each passing millennium. Not only do our ten-millennial descendants, who will at the rate of five generations per century be our five-hundred-times-great-grandchildren, face the problem of finding our words, but they also confront the difficulty of interpreting them through time.

Our future civilizations would benefit greatly from a book that is nearly-indestructible on millennial time scales, resilient and protected from accumulating errors in stored and communicated content, packed densely and accessibly with information available at a touch, self-powered by light energy, easy to handle and use, and carrying in its contents some means for assisting readers unfamiliar with the languages and backgrounds of its creators.

With respect to dense, accessible, easy-to-use, easy-to-contextualize information, one current technology now in development is the electronic literary macramé, or ELM. The ELM provides for creation of standalone, densely-linked, multithreaded, easy-to-use electronic books that give their readers a wealth of methods for exploring entire cultures, languages, and texts from sources separated by time, place, and circumstance from the reader's world. An interlinked set of such electronic books, stored and preserved in a single durable object and easily accessible to a user under a wide range of conditions, would constitute an entire library for its reader, a long-lasting library carried easily in one's hand.

Publishers who want to create digital books, even libraries, that can be handled and treated like any book, that last beyond the lifetimes of generations, that never change their contents or functioning, and that give readers a world of interconnections and threads ELM-style, would seek the ability to create such a library in a single handheld product. The product would be global, a leap out of the existing paradigms, attractive and lasting, a convenient physical handheld object usable with nothing but a light source.

Books will go into space, and into other locales of extreme conditions. Whether they are manuals of operation, reference encyclopedias and databases, work of fiction, chronicles, or any other kind of book, books will be subjected to the rigors of space, sometimes being put under rapid, deep stress: cosmic ray bombardment, EMP, micro-meteor strike, onset of hard vacuum, extremes of temperature, physical shock. Current efforts focus around the hardening of electronic components and systems against damage from these and other sources of stress. Such hardening methods and others still to be developed could serve to keep book technologies working under the most challenging of conditions. A book designed to contain and retain many volumes of information in compact and reliable form over century and millennial time scales, under an unpredictably-variable range of conditions, would constitute an ideal invention for humanity's future in the cosmos.

Finally, any book-type invention, self-contained, digitally active, and long-lasting, would deliver a permanent and transferrable product to its possessors and users. This transferability would confer on such an invention a distinct advantage over contemporary, conventional electronic books.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The “glass book” as realized in the present invention is a sealed stack of layers of durable, amorphous embedding material, such as glass, that strongly resists deterioration over millennium-long time scales. Embedded in the layers are components of silicon and other insulating, semiconductive, and conductive elements and combinations of elements likewise durable. Among these components are energy-capturing and energy-converting power cells to provide electrical energy, charge-storage cells to store power-cell energy and issue electrical power for the book's operation, computer microcircuits, and a durable, large-capacity, static, read-only, permanent memory subsystem. The permanent memory subsystem contains in digital form the texts, images, and other readable or user-presentable material for reading. Also among these components is a digital display component embedded in the embedding material, and a memory resolution component for detecting, correcting, and healing errors in stored and communicated content of the read-only memory. Capacitance coupling, piezoelectric pressure coupling, or other means of tactile engagement through the surface layer enables a user to present touch commands to the book's circuitry to activate and alter the contents of its display for reading from the book's contents. In an optical-interface embodiment, a camera and supporting circuitry and processing, all manufactured into one or more of the invention's component layers, enable a user to present gestural commands likewise to the book's circuitry. In a framing embodiment, the glass book is optionally formed with its power cells, storage cells, microcircuits, and memory embedded in an opaque frame surrounding a transparent window in which the digital display component is embedded. All of the book's components are functionally interconnected. Such a book comprises in its content a highly-durable, broadly-accessible equivalent of an entire interlinked, nearly-indestructible library.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A shows a front view of a solid embodiment of the glass book displaying text.

FIG. 1B shows a sectional view of the embodiment of FIG. 1B.

FIG. 2A shows an exploded side view of the solid embodiment of the glass book with insulating and active layers.

FIG. 2B is a sectional view of the glass book.

FIG. 2C is front view of a memory and processing component layer inside the glass book.

FIG. 2D shows an exploded view of an alternate embodiment of the glass book from a side view.

FIG. 2E is a sectional view of the embodiment of FIG. 2D.

FIG. 2F is a front view of the embodiment of FIG. 2D.

FIG. 3A is another alternate embodiment showing an exposed side view of a glass book with a peripheral frame.

FIG. 3B is a sectional view of the alternate embodiment shown in FIG. 3A.

FIG. 3C is a front view of the alternate embodiment shown in FIG. 3A.

FIG. 4 shows a front view of the framing embodiment of the glass book with touch spots for reader interaction with the book, in which the touch spots show outline response to touch and/or prompt data in each spot as variably required.

FIGS. 5A, 5B respectively show side and front views of the embodiment of FIG. 4 with embedded Faraday-shield circuitry in the book's glass shell.

FIG. 6 shows a partial side cutaway view of protective components and connections used to shield the book's rear photovoltaic surfaces from overload exposure to radiation.

FIG. 7 shows a side cutaway view of protective components and connections used to shield the book's front and rear photovoltaic surfaces from overload exposure to radiation.

FIG. 8 shows a side cutaway exploded view of the solid embodiment of the glass book with all interlayer connections.

FIG. 9 shows a side cutaway exploded view of the solid embodiment of the glass book with all interlayer connections.

FIG. 10 shows a side cutaway exploded view of the framing embodiment of the glass book with all interlayer connections.

FIG. 11 shows an angled view of the active layers of the framing embodiment of the book in exploded form.

FIG. 12 shows an angled view of the active layers of the framing embodiment of the book in assembled form, with light transmission through the frame opening indicated.

FIG. 13 shows a block diagram of the functional component interconnections of the glass book.

### DETAILED DESCRIPTION

Current practice in the fabrication and use of digital books (“e-books”) integrates the stability and handling features of printed books with the capabilities and advantages of digital processing and media, i.e., flexibility of presentation, incorporation of search and lookup automation, and immense storage capacity. The present invention embraces both sets of virtues with special attention to permanence, durability, and stability, to give readers a digital work comprised of stored digital content accessible to a human user. Unlike typical e-books, however, the present invention eschews connection to remote sources of information in order to eliminate all sources of potentially-corruptive code that might damage or destroy the digital contents of the invention. Such a digital work as stored in the present invention withstands the degenerative effects of long spans of time, well beyond the time limits of a printed book's functional durability by orders of magnitude.

Pure glass—silicon dioxide in pure form, also called quartz glass—has a lifespan exceeding centuries, and is especially hard and resistant to damage. Sodium borosilicate glass has a lengthy lifespan as well, but it also adapts better to changes in temperature. Alkali-aluminosilicate thin sheet glass, known under the brand name Gorilla Glass) is very thin and very strong, but its expected lifespan is not as well understood.

In conventional usage, the term ‘glass’ refers to non-crystalline (amorphous) silicon dioxide both in pure form and in combination with other substances such as sodium carbonate, lime, magnesia, alumina, boric oxide, and lead oxide. The present specification follows conventional usage for the term, specifying where necessary any needed variations of content to meet the requirements of particular components.

In conventional usage, the term ‘vitreous’ refers to glass-like substances. Here the term is used as a modifier to refer to glass itself.

Where transparency is not required in a specific component, substances not yielding transparency may be used. Such substances may include crystalline, non-crystalline (amorphous), and combinations of crystalline and non-crystalline elements, and may or may not contain silicon dioxide (e.g., network glasses, amorphous metals, glass-ceramics). Here the term “durable glass-like material” is used to refer to the class of substances that includes both glass and all other formulations such as network glasses, amorphous metals, and glass-ceramics.

The present invention, termed here the “glass book”, incorporates both glass and durable glass-like materials suitably configured as described herein.

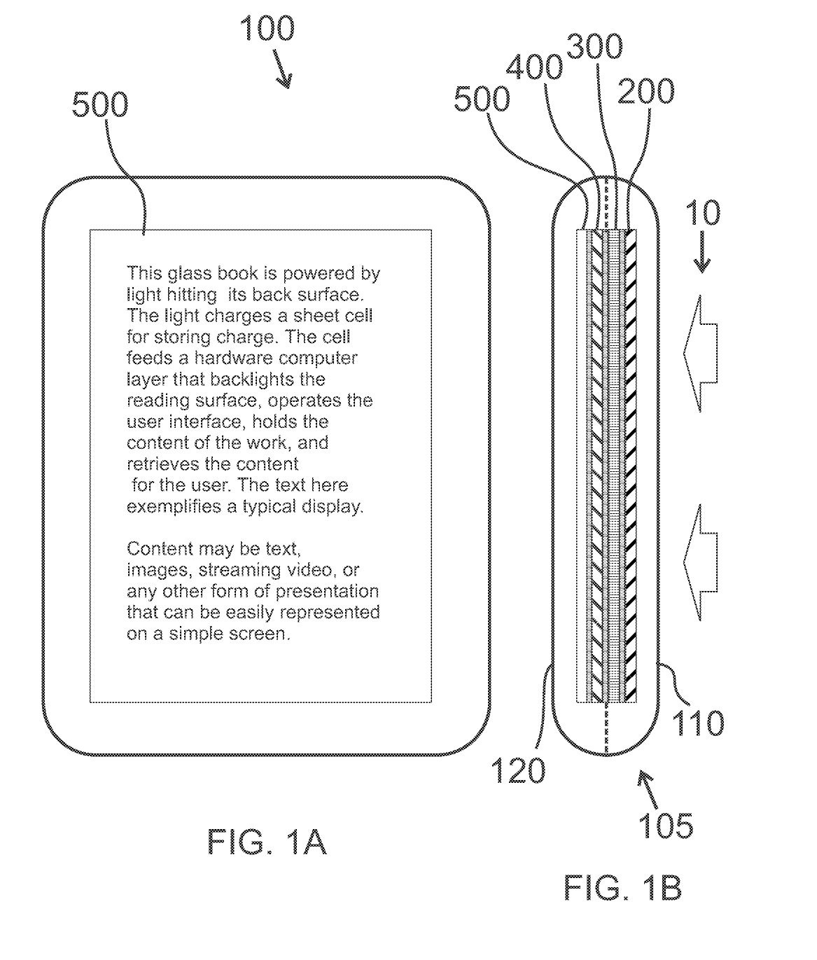

See FIG. 1. In its principal embodiment, the glass book 100 is powered by photonic radiation 10, such as light, hitting its transparent outer rear shell 110. The light charges an energy-conversion component 200 such as a photovoltaic panel used for acquiring electrical charge. The energy-conversion component feeds acquired electrical charge to an energy-storage component 300 such as a battery, capacitor, or ultracapacitor, for storage. Energy-storage component 300 powers a hardware computer processing and memory component layer 400 that provides contrastive background to a display layer 500, operates the user interface, retains the content of the work in its memory, and displays the stored content for the user through its transparent outer front shell 120. Transparent outer rear shell 110 and transparent outer front shell 120 are seamlessly and invisibly joined at their edges to form sealed outside shell 105 of glass book 100. The book contains no software modifiable in its permanent memory, because the code being executed is hard-stored and backed up, with forward-error-correction functions built in for all digital elements in use in computation.

Transparent outer front shell 120 and transparent outer rear shell 110 are fabricated from one or more forms of glass, exemplified by quartz glass, sodium borosilicate glass, and alkali aluminosilicate glass, that combine best the desired properties of lifespan, transparency, thermal resiliency, and physical toughness.

The present invention incorporates electronic, photonic, or hybrid circuitry connecting its functional elements, all of which are permanently embedded in an insulating medium such as silicon dioxide, silicon, or other insulating substrate. The electronic circuitry comprises conductive traces functionally connecting semiconductive, resistive, capacitive, photovoltaic, radiosensitive, inductive, piezoelectric, inertial, and other energy-conversion elements likewise embedded permanently in the insulating medium.

Conductive traces are conventionally fabricated via metal deposition or similar processes known in the art on an insulating substrate that is both electrically and thermally insulating. Similarly, functional elements such as semiconductors, resistors, capacitors, photovoltaics, and others are conventionally fabricated via deposition and doping of a substrate with metals and other elements possessing properties suitable for their functions. Conventional practice teaches the minimization of the size, mass, and cost of all such elements to allow the greatest degree of miniaturization of the complete assemblage of elements.

The reduction of the size and mass of circuit elements to the nanometer scale brings with it an increased fragility of the complete assemblage of those elements. With every decrease in size of a circuit element, a single disruptive event such as a physical shock, a cosmic particle collision, an electromagnetic pulse, a chemical immersion, or a microbial contamination may have disproportionate impact on the integrity of the data and programs of the complete assemblage. Furthermore, slow processes such as leaching or migration at the atomic level over extended time periods may render doped or deposited materials nonfunctional. Memory elements relying on long-term charge storage eventually lose part or all of the stored charge due to leakage.

The present invention, in its most durable embodiments, instead follows the practices and standards for radiation hardening developed by NASA for spacecraft device protection. Consequently the present invention teaches the use of traces and circuit elements of a composition and size to provide an acceptable balance between limiting the overall weight and size of the invention and limiting its fragility and deterioration rate.

Also in consequence, long-term memory storage in the present invention requires immunity to charge leakage, dopant migration, or other similar kinds of slow deterioration. The present invention teaches the use of multiple tiers of memory of diverse types, tiers that may be used in combination to render the original memory contents with maximum accuracy and reliability.

The stored digital content may be text, images, streaming video, or any other form of presentation that can be easily represented for a user via a visible screen and an optional audio output. The present invention's ability to withstand degeneration over long time periods urges the storage and use of digital works especially suited for the broadest possible range of readers and other users, such as the kinds of digital works produced by use of ELM (electronic literary macramé) technology. The ELM technology and its processing and presentation features are specified in U.S. Pat. Nos. 7,555,138; 7,801,021; 8,010,897; 8,091,017; and 8,689,134, by the present inventor; in U.S. patent application Ser. Nos. 11/828,010; 12/924,779; 13/069,036; and 13/307/695, by the present inventor; and in disclosures made public elsewhere by the present inventor titled “Method and Apparatus for Providing Unique Per-copy Digital Watermarks” and “Method and Apparatus for E-book Layout and Presentation of ELM and KTT Content”, all of which patents, patent applications, and disclosures are incorporated herein by reference.

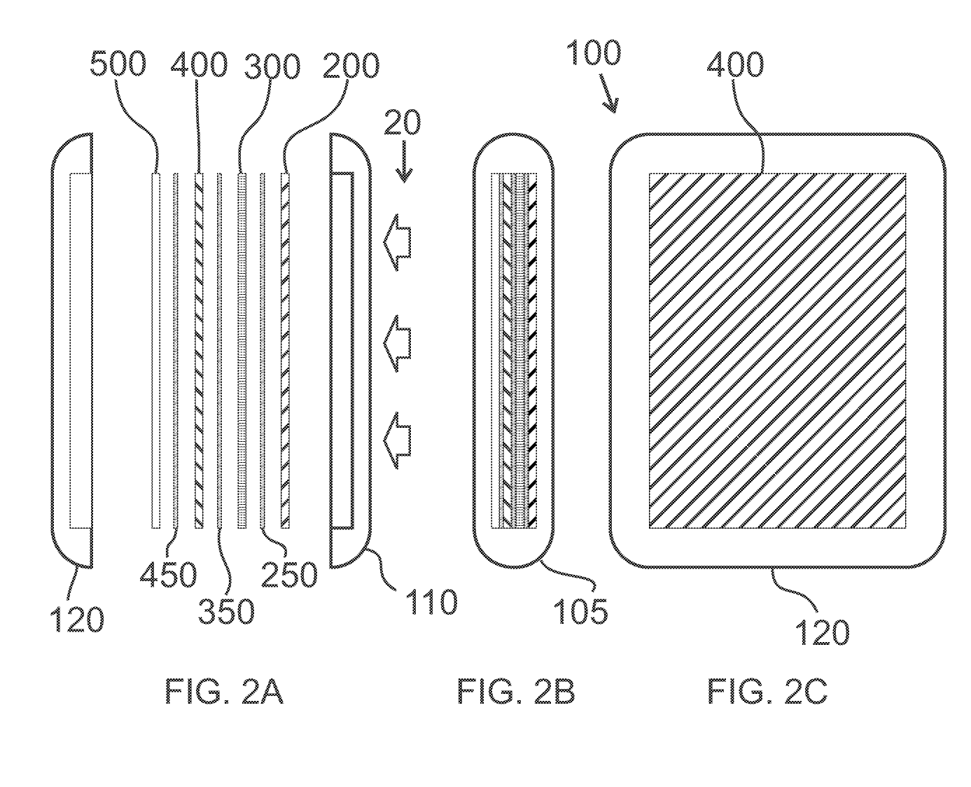

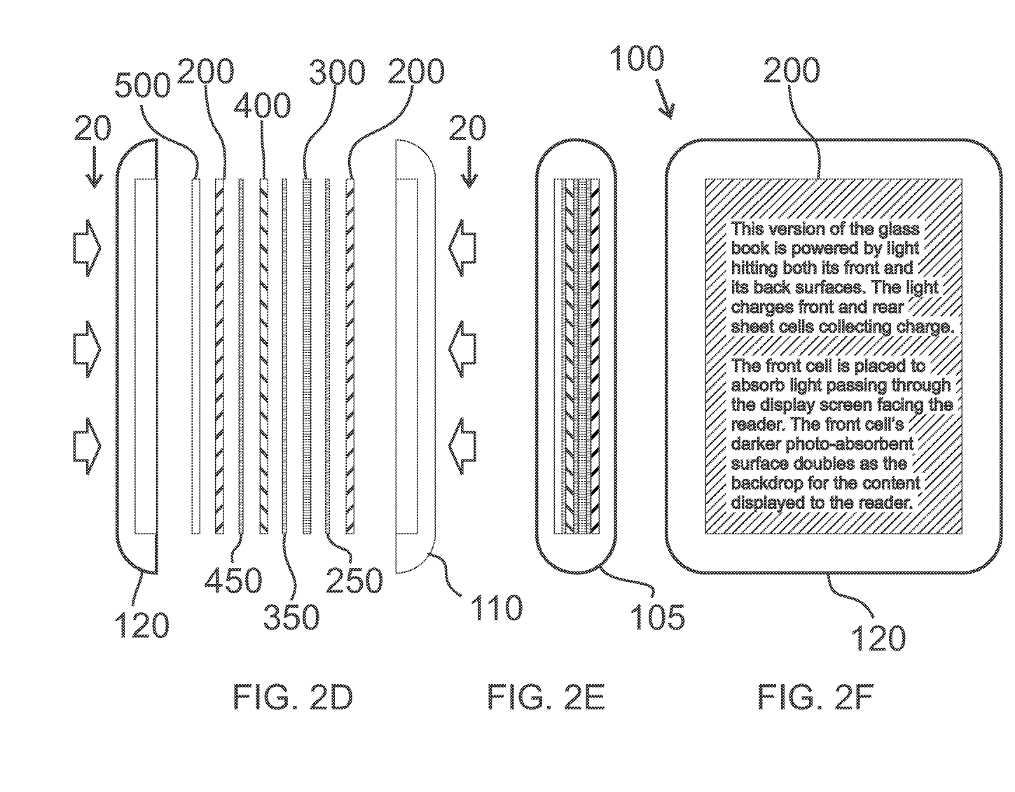

The invention's containing component is a set of flat layers of hard, durable glass-like amorphous material such as glass in which the remaining components are permanently embedded. The flat layers incorporate four active layers 200, 300, 400, 500, and passive insulating layers 250, 350, 450 as shown in FIGS. 2 and 3.

The first active layer, energy-conversion component 200, comprises a set of energy-conversion elements, including and not limited to photovoltaic elements, embedded in the book's durable glass-like material for converting ambient energy into electricity for supply to the book's energy-storage component of the second active layer, energy storage component 300.

In light-energy embodiments, first active layer 200 comprises a set of photovoltaic elements embedded in the book's durable glass-like material for converting light energy into electricity for supply to the book's energy-storage component of second active layer 300.

In radio-energy embodiments, first active layer 200 comprises a set of antenna elements embedded in the book's durable glass-like material for converting radio-frequency energy into electricity for supply to the book's energy-storage component of second active layer 300.

In particle-energy embodiments used in high-radiation environments, first active layer 200 comprises a set of sublayers embedded in the durable glass-like material of glass book 100 for capturing electrical charge or photonic energy resulting from particle collisions with one or more components of the invention, for supply to the book's energy-storage component of second active layer 300.

Second active layer 300 comprises an energy-storage component such as one or more storage batteries, capacitors, or ultracapacitors embedded in the book's durable glass-like material and connected for supply purposes to the processing circuitry and memory of the book's third active layer, processing and memory layer 400, and connected for buffering and storage purposes to the book's elements of first active layer 200 for capturing electrical or photonic energy.

The energy-storage component of active layer 300 is not required to retain charge in storage for periods of time that would exceed substantially the length of an ordinary reading encounter with a reader. The normal state of the energy-storage component is an uncharged state in which no electrical energy is retained—a ground state. This teaching mitigates issues which arise in the long-term retention of charge such as leakage, migration of charge-holding atoms and molecules, and other effects deleterious to the long-term life of any energy-storage component. The energy-storage component is charged just before and during the time of reading, via energy transfer from first active layer 200. At the end of reading any remaining charge is allowed to dissipate through other components of the invention, e.g., allowing the display to continue to emit light, thereby mitigating the long-term issues of charge storage.

The third active layer, processing and memory component 400, comprises processing and computing circuitry embedded in the book's durable glass-like material and connected to display layer 500, to retrieve portions of book contents from memory, regulate and distribute the power provided by the book's energy storage component of the second active layer 300, and communicate with the topmost layer, display layer 500, to display the book's readable contents and respond to reader cues.

The third active layer 400 also comprises static, read-only memory embedded in the book's durable glass-like material to contain the readable components of the book, connected to the book's processing circuitry.

The fourth active layer, display layer 500, comprises a transparent interaction surface layer for readers, through which portions of the readable contents of the book may be viewed, and through which the book's processing components of the third active layer 400 may receive cues from the reader. Reader cues include requests for changing the display format, changing the presentation of contents, and activating or deactivating the book.

Substantially coplanar with display layer 500 is the fifth active layer, sensor layer 600, incorporating in the present invention one or more subsystems for capturing and communicating reader input cues. In a tactile-cue embodiment, sensor layer 600 is fabricated with organized elements for charge, inertial, orientation, and pressure detection, separately or in combination. Capacitive, inertial, and piezoelectric coupling with reader touch, movement, or proximity send localized signals to active layer 400. In a visual-cue embodiment, sensor layer 600 is fabricated with one or more cameras, each with its lens manufactured into one or more sublayers, to capture images and motion from the reader and the reader's surroundings for communication to active layer 400. In a combined reader-cue embodiment, both tactile-cue and visual-cue detection and capture methods are combined.

In a combined reader-interface embodiment, display layer 500 and sensor layer 600 are integrated into a single surface layer providing both display and input functions.

Every active layer 200, 300, 400, 500, and 600 may be constructed so as to situate its working components, as described herein, in a shock-resistant, fully-insulated, framework. In a layer-filling embodiment, a component's surfaces are flush with the surfaces of the containing layer itself, thereby obviating the addition of any framework to the layer. In a layer-framework embodiment, a component is embedded fixably in a medium that is long-lasting, suitably shock-resistant, thermally-insulating, electrically-insulating, photonic-shielded, or a long-lasting medium combining two or more of these insulating properties. In a layer-hybrid embodiment, a component has one or more surfaces flush with surfaces of the component's layer, and one or more surfaces embedded fixably in a medium as described above.

In all layer embodiments, every element of every layer, and the layers themselves, must fit together at tolerances in the submicron range, thereby precluding the development over time of significant concentrations of outgassed substances within the glass book 100. As for each interior layer, the sealed outer shell 110, 120 of glass book 100 has every interior surface flush surface-to-surface with each contiguous interior layer so that all air, gas, or fluid is squeezed out, with any remaining gaps or pockets evacuated, in best embodiments, before sealing. In lieu of vacuum, an inert insulating medium such as a nonreactive gas or fluid may be substituted in gap-filled embodiments. Any medium used for embedding components as described above must meet useful-lifespan requirements of the glass book 100. In exemplary embodiments, members of the family of polysiloxanes offer some of the best levels of working lifetime, shock resistance, corrosion resistance, insulation of all types, and opacity.

In thermally-conductive embodiments, a medium such as alumina-loaded glass is used for embedding computing components in order to carry away excess heat generated during high levels of use. Over the glass book's lifetime, the expected ratio of active use time of the glass book to the duration of its passive, powered-down state is minuscule. It is expected that a glass book will spend much of its existence sitting powered down, with only low levels of thermal and radiation stimulation of any kind. Heavy, intense, continuous use is prevented via conventional hardware/firmware safeguards to limit its periods of use and exposure to potential sources of degradation of its internals.”

Light, considered broadly as photonic radiation in the infrared, visible, and ultraviolet spectra, encountering the back surface of the book is used differently in two distinct embodiments of the invention. In a solid, light-blocking first embodiment shown in FIG. 2, first active layer 200 provides a light-gathering surface across the entire plane of the book that blocks the transmission of light from the energizing source through the book to the reader. In this first embodiment, energy-conversion component layer 200, energy-storage component layer 300, and the third active layer, processing and memory component 400, all fill the whole area behind the fourth active layer, display layer 500, requiring that layers 300 and 400 provide both foreground and background energy to display layer 500 for displaying the book's readable contents.

In a framing, light-transmitting second embodiment shown in FIG. 3, the outside periphery of glass book 100 incorporates first active layer 200, energy-storage layer 300, and processing and memory component 400 as a frame 900, providing a frame-shaped energy-conversion component 200 that leaves open the space 950 within the frame for the transmission of light through glass book 100 from the transparent outer rear shell 110 to and through display layer 500. All elements of the processing and memory layer 400, energy-storage component layer 300, and energy-conversion component layer 200 lie only beneath frame 900, leaving transparent or translucent the center portion 950 of glass book 100 as seen by the reader.

Conventional technologies furnish see-through display options for the framing embodiments illustrated in FIG. 3 and in subsequent figures. Examples of display technology options include organic light-emitting diodes (OLEDs), liquid-crystal displays (LCD), and different forms of “smart glass” including electrochromic, photochromic, thermochromic, micro-blind, and suspended-particle, providing different degrees of durability, transparency, color, opacity, reflection, resolution, intensity of display, and power demand, as distinct embodiments of the present invention may require.

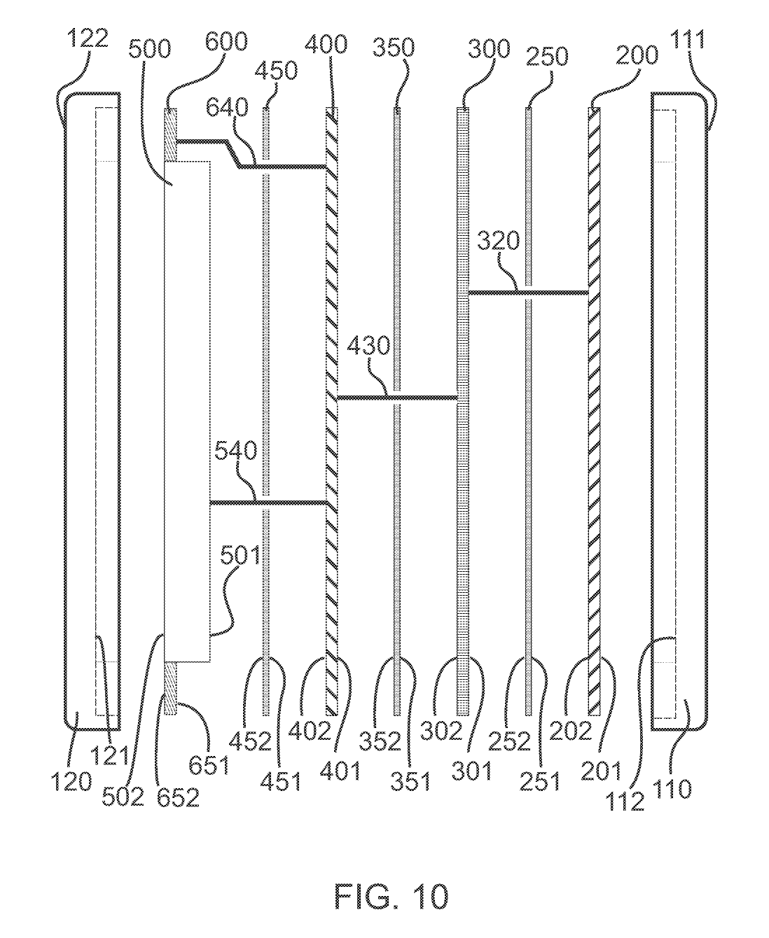

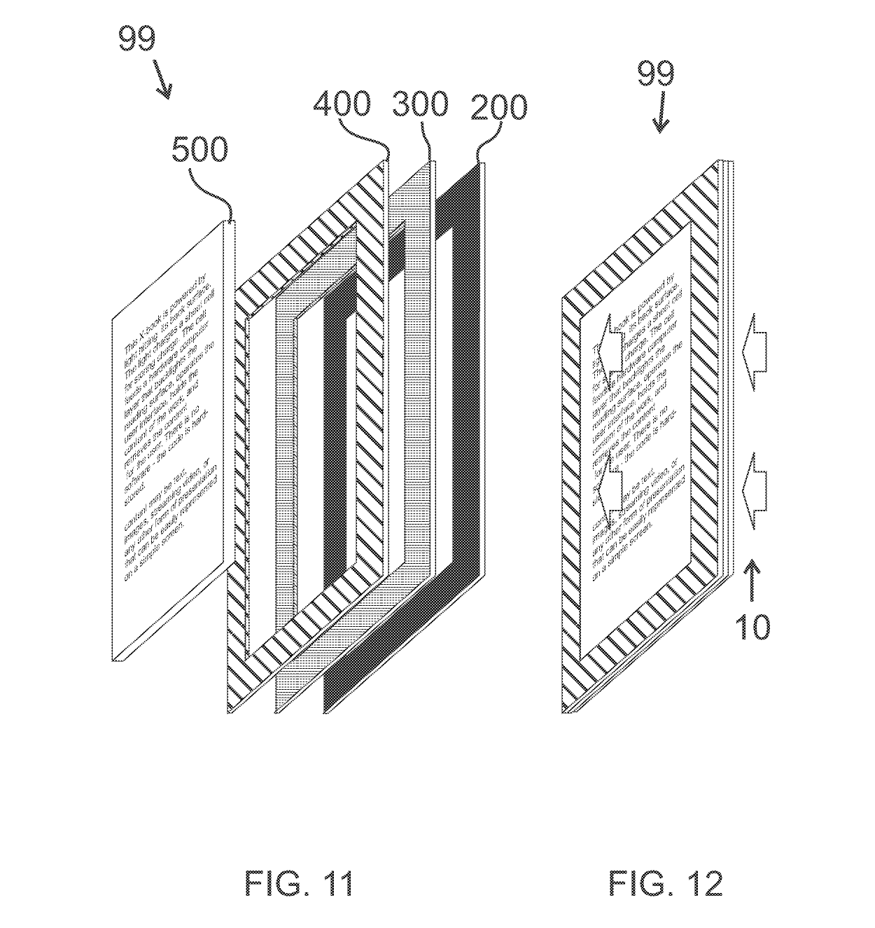

The organization and assembly of the light-transmitting second embodiment of the invention's active layers 200, 300, 400, 500 into the book's active layer assembly 99 are shown in FIGS. 11 and 12. FIG. 12 also shows the transmission of photonic radiation 10, such as light, from the back of the book's active layer assembly 99 through display layer 500 displaying the book content to the reader.

In the light-transmitting second embodiment, photonic radiation 10, such as light, transmitted through transparent display portion 950 from the back of the book provides an externally-illuminated background against which the readable contents of the book may be presented contrastively, presenting the reader with a see-through display as conventionally available with existing and developing technologies such as OLEDs or LCD.

A transparent light-transmitting embodiment further incorporates a see-through display for overlay of the user's surroundings as viewed through the transparent display portion 950 of the book with the book content as presented on the screen.

As a variation of the transparent light-transmitting embodiment, an augmented-reality embodiment further incorporates sensors for position, location, orientation, and imaging, together with correlative computational elements in the present invention, all fabricated fully into the invention's active layers. Said computational elements situate glass book 100 in its environment, search the book's memory for information relating within limits to the book's position, orientation, location, and surroundings, retrieving said information, and incorporating said information in displays in display layer 500 overlaid on the external view presented through transparent display portion 950. The augmented-reality embodiment effectively integrates the reader's perception of the book content and the objects, images, and settings viewable behind the book.

The augmented-reality embodiment's sensors, and correlative computational elements in combination with the book's memory contents may be further augmented with a data-input component to receive and process information from an external source without allowing modification of book content as defined hereinabove. Such a data input is used to substitute virtual position, location, and orientation for the sensor data from the augmented-reality embodiment's position-sensing, location-sensing, and correlative computational elements, thereby positioning the book in a virtual world. The book's content may be then overlaid with the view of the virtual world as seen through the book's display portion, allowing a virtual arrangement of objects, images, and settings to be presented to the reader from behind the book overlaid with the book's content. For example, holding the book up to an external screen or holographic display and having the book process positioning information provided by the external display via the data-input component situates both the book and its reader in a virtual-reality setting, constituting a virtual-reality embodiment of the book.

Other sensing embodiments containing sensors such as range finders, cameras, microphones, thermometers, and other sensing devices, all integrated fully into the invention's active layers, provide functions enabled by the processing of inputs from such sensors combined with the book's contents. In all applications wherein the book accepts sensor input, no alteration to book content or processing programs is provided for.

Light-transmission-variability embodiments of the present invention incorporate translucency and variable transparency elements to improve readability of presented content, to facilitate the reader's integration of presented content with the objects, images, and settings visible through the display portion of the book, and to provide reflective protection of the invention's components during exposure to high levels of reflectable radiation.

A translucent light-transmission-variability embodiment further incorporates a diffused-light background against which book content may be presented in the display portion of the book in display layer 500, thereby reducing any energy demands required by the need for book-generated backlighting of the display.

A first variable-transparency light-transmission-variability embodiment further incorporates a variable-transparency panel between display layer 500 displaying the book content and the transparent display portion 950 of the book, further providing the user with the ability to see objects, images, and settings through the display portion of the book while maintaining a degree of legibility and clear visibility of book content in the same display portion of the book by varying the transparency of the variable-transparency panel.

A second variable-transparency light-transmission-variability embodiment further incorporates variability of background transparency in the features of the display layer 500 displaying the book content and the transparent display portion 950 of the book, further providing the user with the ability to see objects, images, and settings through the display portion of the book while maintaining a degree of legibility and clear visibility of book content in the same display portion of the book by varying the background transparency of the display layer 500.

Said variable-transparency embodiments may be combined with the features of the augmented-reality embodiment to vary the relative legibility and visibility of the book content and the objects, images, and settings behind the book.

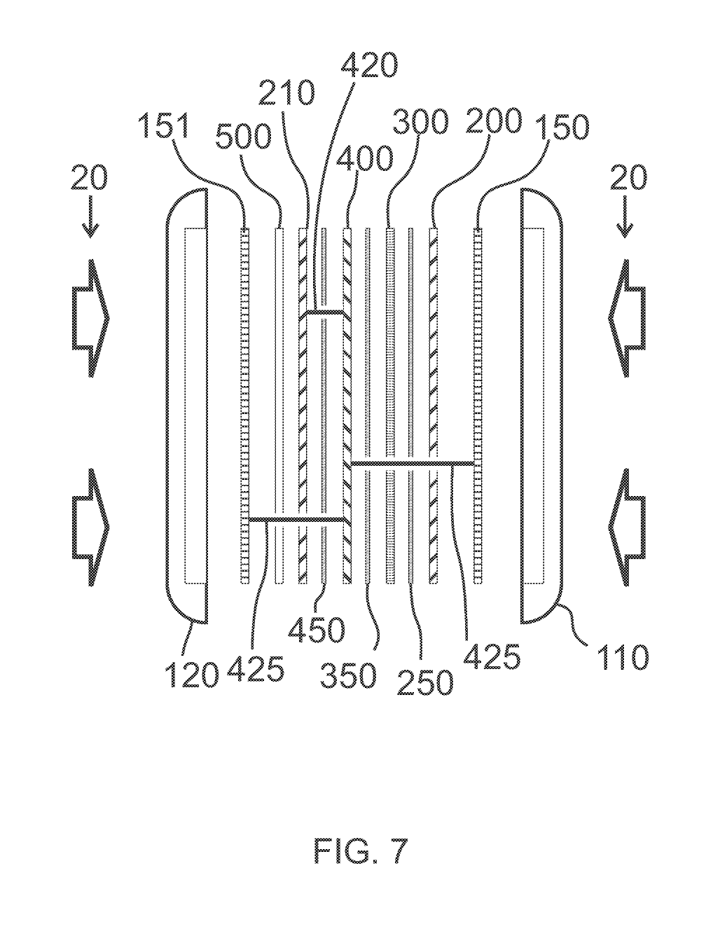

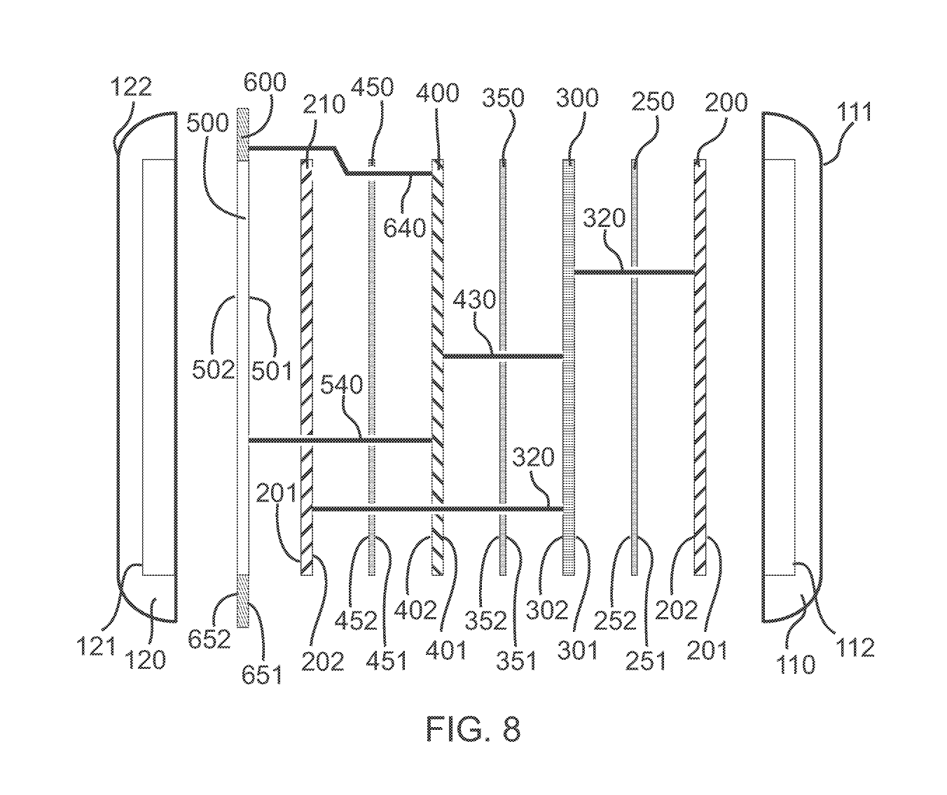

See FIGS. 2D-2F. Alternative energy-conversion embodiments provide for the use of energy-conversion elements receiving energy from sides, top, bottom, and/or front of glass book 100. For instance, in a sandwich energy-capture embodiment, energy-conversion layer 200 is replicated under display layer 500 and above passive insulating layer 450 to capture photonic radiation 10 passing inward through transparent outer front shell 120 and display layer 500, as well as photonic radiation 10 passing inward through transparent outer rear shell 110. Energy-conversion elements may also be positioned and used on any other face of the invention. In FIGS. 8 and 9, conductive connections 320, 430, 540, and 640 are shown, illustrating inter-layer connections in glass book 100. Wherever conductive connections pass through layers with conductive properties, said conductive connections require insulation from said layers.

Conductive connections 320, 430, 540, 640 and any others in the present invention may comprise electronic, photonic, or other types of connections for conveying information or power without significant loss.

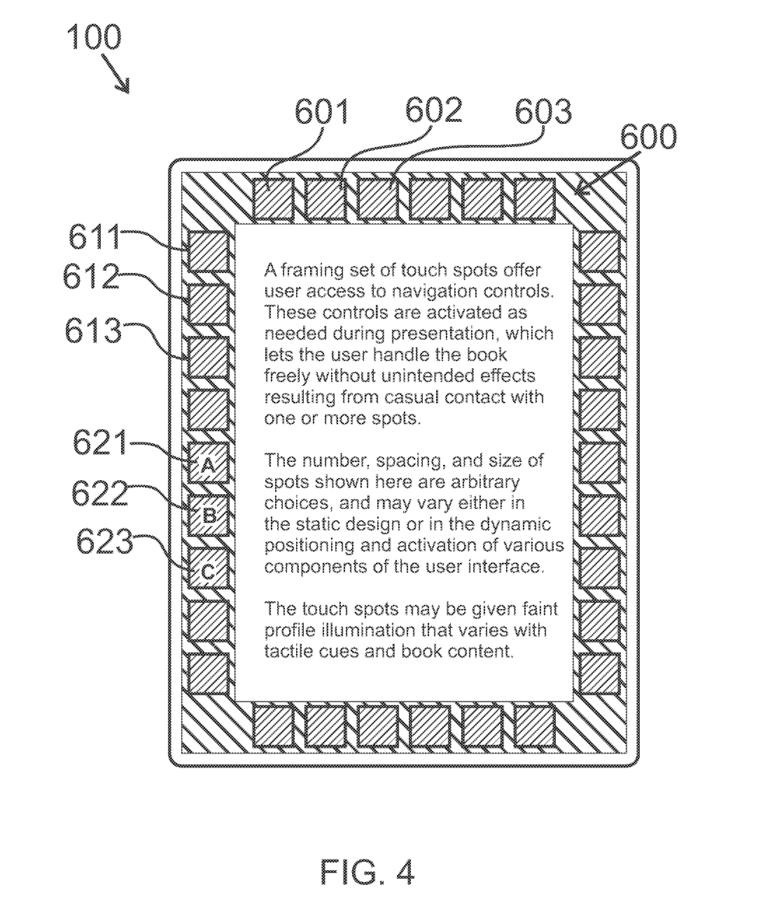

See FIGS. 5A, 5B. An electromagnetically-shielded embodiment incorporates Faraday shielding 1051 in the sealed outside shell 105 of glass book 100 so as to allow reader access to controls for the book's display of content while preventing the penetration of damaging electromagnetic radiation. An exemplary form of the electromagnetically-shielded embodiment embeds the Faraday shielding 1051 in the form of a web of conductive paths fabricated into the insulating glass of the sealed outside shell 105.

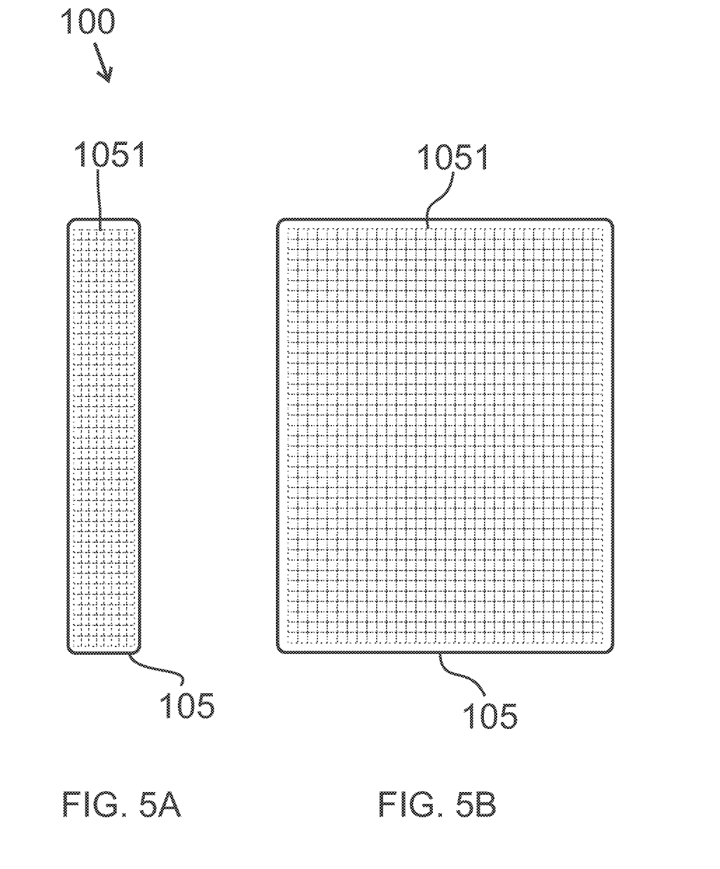

See FIG. 6. An optically-shielded embodiment incorporates protective circuitry in third active layer 400 to provide reflective protection of the invention's components during exposure to high levels of reflectable radiation. One or more sensors in layer 600 or in layer 200 detect intense photonic radiation 20 directed at energy-conversion layer 200. Memory and processing layer receives the output of sensors in layers 600 and 200 and activates protective responses to power-input overload through the book's transparent outer rear shell 110. The optically-shielded embodiment also incorporates electrically-activated shield component 150 between transparent outer rear shell 110 and active energy-conversion component layer 200 which may be converted by signals from the third active layer, processing and memory component 400, from a normal operating state of photonic transparency to a protective state of photonic reflection. When potentially-damaging input of excessively-intense photonic radiation 20 strikes active energy-conversion component layer 200, said active layer 200 sends a signal via conductive connection 420 to the protective circuitry in active processing and memory component 400, which then activates protective response including the activation of electrically-activated shield component 150 via conductive connections 425, thereby reflecting away or otherwise weakening as much of the potentially-damaging intense photonic radiation 20 as possible.

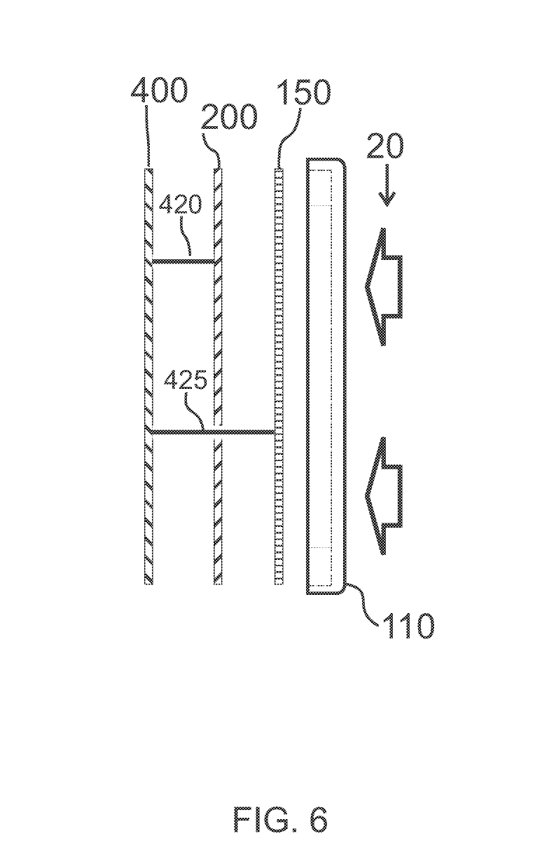

See FIG. 7 for an optically-shielded energy-conversion embodiment wherein intense photonic energy may be directed at energy-conversion elements on multiple faces of glass book 100. The embodiment of FIG. 7 has front and rear shield layers 151, 150, respectively to protect front and rear energy conversion layers, 210, 200, respectively. In an exemplary form that in addition to its incorporation of electrically-activated shield component 150 adjacent to outer rear shell 110, the optically-shielded energy-conversion embodiment also incorporates a second electrically-activated shield component 151 between transparent outer front shell 120 and display layer 500 which may be converted by signals from third active layer, processing and memory component 400, from a normal operating state of photonic transparency or display to a protective state of photonic reflection. When potentially-damaging input of excessively-intense photonic radiation 20 strikes display layer 500, said layer or sensors embedded in said layer 500 sends a signal via conductive connection 420 to the protective circuitry in third active layer 400, which then activates protective response including the activation of electrically-activated shield component 150 via conductive connections 425.

A fast-reaction embodiment embeds protective circuitry directly in front and rear energy conversion layers 210, 200, thereby obviating the use of connections 425 in favor of much-shorter connections between layers 210, 200 and electrically-activated shield components 151, 150 respectively.

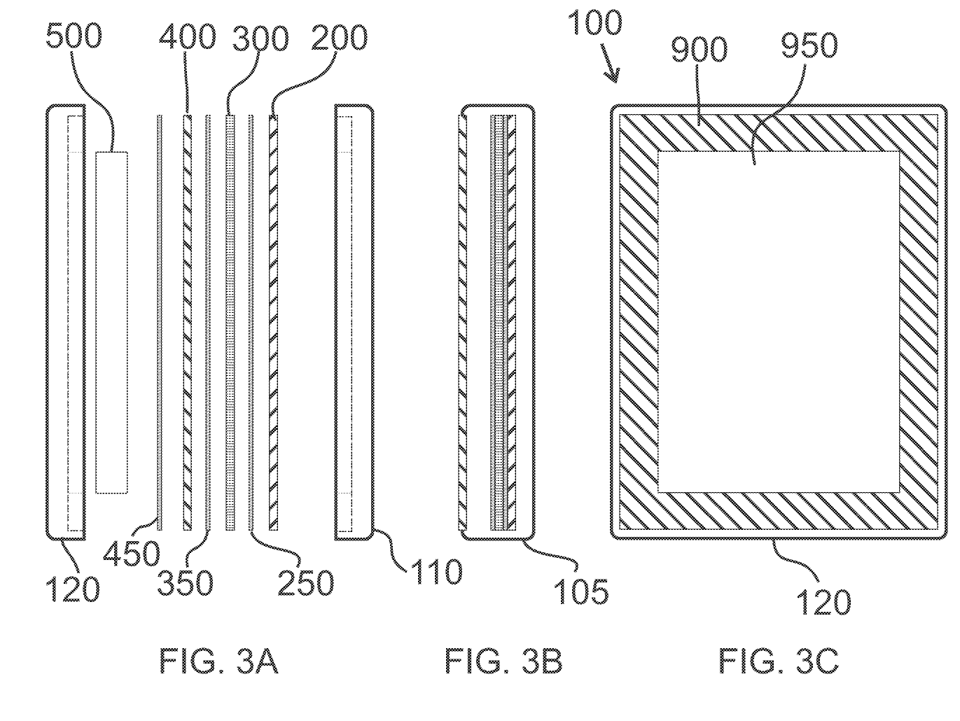

See FIG. 4. In sensor-enabled embodiments of the invention, a sensor layer 600 comprised of touch or capacitance-coupled spots 601, 602, 603, etc. surrounding the display portion of display layer 500 provide simplified reader access to navigation and selection controls. These controls are activated as needed during presentation by active layer 400, letting the user handle glass book 100 freely without unintended effects resulting from casual contact with one or more spots. The number, spacing, and size of spots 601, 602, 603, etc. shown in FIG. 4 are arbitrary choices, and may vary either in the static design or in the dynamic positioning and activation of various components of the user interface.

Touch or charge-coupled interaction originated by the reader for the book is not restricted to the framing set of spots of sensor layer 600. In touch-screen embodiments, conventional means in contemporary screen devices such as pads and smart phones are used to gather input from the reader directly from the display surface of top layer 500.

In reader-feedback embodiments, the touch spots of sensor layer 600 are given faint profile illumination 611, 612, 613, etc. or similar highlighting that varies with tactile or charge-based cues.

In reader-prompting embodiments, the touch spots of sensor layer 600 are supplemented with titling 621, 622, 623, etc. that the third active layer, processing and memory component 400, varies from display to display as determined both by reader interaction and by book content. Said titling comprises textual or iconic prompts generated as dynamic displays by processing and memory component 400.

### COMPOSITION OF THE EMBODIMENTS OF THE INVENTION

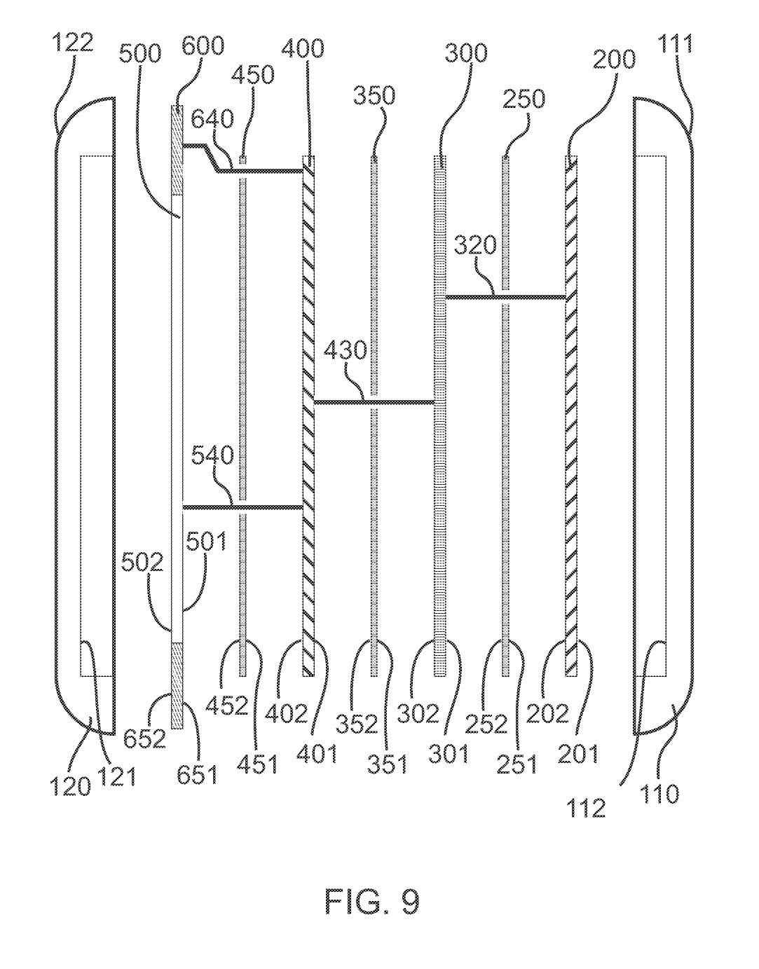

The embodiments comprise the following durably-functional elements, formed, organized, and joined as follows (see FIGS. 9 and 10):
1. A passive, hardened, toughened, transparent, flat-surfaced outer rear shell 110 of durable glass-like insulating material such as glass, having an exterior rear planar surface 111 allowing handling and access by external means, and an interior planar surface 112.
2. One or more active, flat energy-conversion components, for example photovoltaic elements, 200 arranged in uniform planar fashion, each having a first planar surface 201 in full contact with the entire interior planar surface 121 or 112 of transparent outer front, rear shells 120, 110, and a second planar surface 202, said photovoltaic elements 200 for converting photonic radiation directed at the first planar surface 201 to electrical current.
3. A passive, first flat insulating layer 250 of durable glass-like insulating material such as glass having a third planar surface 251 in full contact with the entire second planar surface 202 of the one or more energy-conversion components 200, and having a fourth planar surface 252.
4. One or more active, flat, durable, energy-storage components such as batteries or solid-state capacitors arranged in single-planar fashion in an energy-storage component layer 300 with a fifth planar surface 301 in contact with the fourth planar surface 252 of first flat insulating layer 250 of durable glass-like transparent insulating material and a sixth planar surface 302 opposite the fifth planar surface 301, and connected via two or more conductive connections 320 to the one or more flat energy-conversion components 200. Conductive element 320 passes through an insulated via in active layer 400.
5. A passive, second flat insulating layer 350 of durable glass-like insulating material such as glass having a seventh planar surface 351 in full contact with the entire sixth planar surface 302 of energy-storage component layer 300, and an eighth planar surface 352 opposite the seventh planar surface 351.
6. An active computer system comprising a processing and memory component 400, fabricated on an insulating substrate such as a direct bonded copper substrate or else fabricated on single-crystal silicon, silicon on insulator or silicon on sapphire, is arranged as a flat set of processing and memory elements, having a ninth planar surface 401 and a tenth planar surface 402 opposite the ninth planar surface 401. Processing and memory component 400 is connected to the energy-storage component layer 300 via two or more conductive connections 430, with its ninth planar surface in full contact with the eighth planar surface 352 of the second flat insulating layer 350 of durable glass-like transparent insulating material.
7. A passive, third flat insulating layer 450 of durable glass-like insulating material such as glass, having an eleventh planar surface 451 surface in full contact with the entire tenth planar surface 402 of the computer system and a twelfth planar surface 452 opposite the eleventh planar surface 451.
8. An active, flat display layer 500 of electronic components connected to processing and memory component 400 via two or more conductive connections 540, having a thirteenth planar surface 501 in contact with the twelfth planar surface 452 of the third flat insulating layer 450 of durable glass-like transparent insulating material, and having a fourteenth planar surface 502 opposite the thirteenth planar surface 501, for rendering signals from processing and memory component 400 visible for reading from a direction opposite to said third flat insulating layer 450.
9. An active, flat sensor layer 600 of electronic components (see FIGS. 4, 8, and 9) coplanar with active, flat display layer 500, having a fifteenth planar surface 651 in contact with the twelfth planar surface 452 of the third flat insulating layer 450 of durable glass-like transparent insulating material, and having a sixteenth planar surface 652 opposite the thirteenth planar surface 501, connected to processing and memory component 400 via two or more conductive connections 640 for rendering signals from external sources accessible to said layer 400 from a direction opposite to said third flat insulating layer 450.
10. A passive, hardened, toughened, transparent, flat-surfaced outer front shell 120 of durable glass-like insulating material such as glass, having an interior planar surface 121 in contact with fourteenth planar surface 502 of active, flat display layer 500 and sixteenth planar surface 652 of active, flat sensor layer 600, and an exterior front planar surface 122 allowing handling and access by external means.
11. A thin, passive, toughened, seamless layer of durable glass-like transparent insulating material such as glass bonding transparent outer rear shell 110 and transparent outer front shell 120 and sealing all other elements of the embodiments permanently between the outer rear shell and the outer front shell, thereby providing protection of above said active layers from physical, chemical, electrical, and thermal damage.

The sequence of layers listed above and illustrated in FIGS. 1-3, 8-11 is exemplary. Compare FIG. 9 and FIG. 8. In the sandwich energy-capture embodiment, the incorporation of an additional energy-conversion component 200 adjacent to display layer 500 as shown in FIG. 8 requires incorporation of additional conductive connection 320 between energy-conversion component 200 and electric-charge-storage component 300. In reordered-layer embodiments of the present invention, interconnections among interior active layers 300, 400 and to active layers 200, 500, 600 permit layers 300 and 400 to be incorporated in reverse order. Insulating layers 250, 350, and 450 may also be reordered as required by such changes.

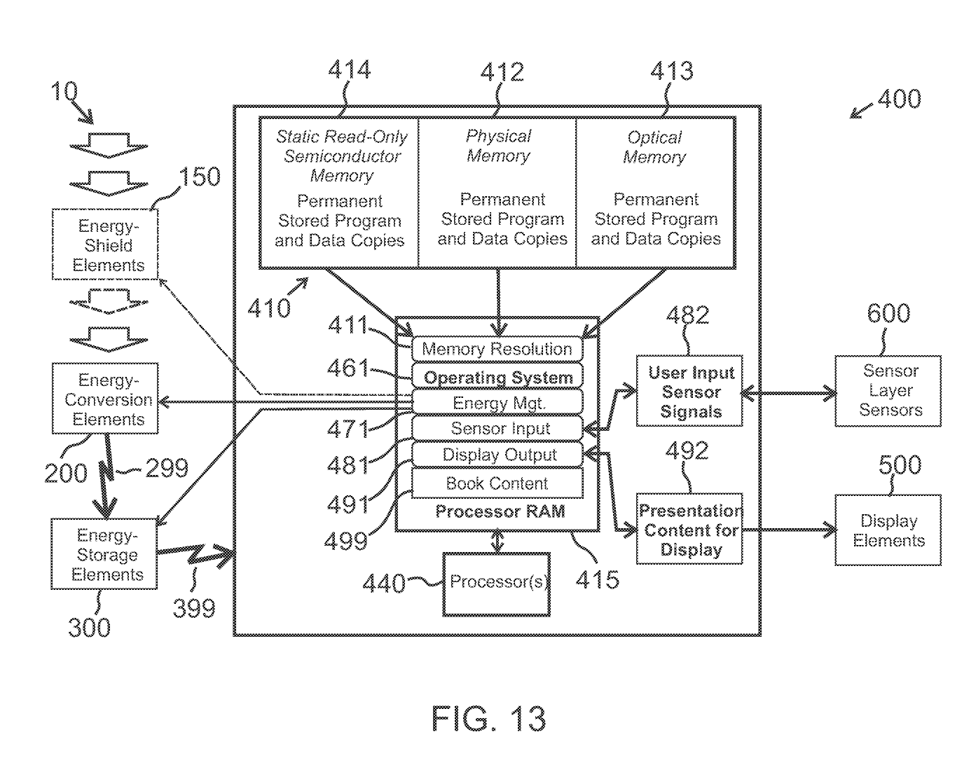

The active computer system, processing and memory component 400, incorporates a memory resolution component 411 (see FIG. 13), for detection, correction, and repair of errors in stored content and transferred content. Damage causing such errors may result from physical shock, chemical contamination, electrical discharge, magnetic field fluctuations, electromagnetic radiation, particle impacts, and thermal extremity, among other causes. Memory resolution component 411 incorporates means for corrective treatment of the following: single-event errors such as upsets, latchups, gate ruptures, or burnouts; or burst errors of various lengths such as impulse noise, fading, erasure, loss, or interference. Memory resolution component 411 serves multiple storage technologies: charge-based, magnetic, optical, spin-based, physical, and combinations of these. Memory resolution component 411 provides coverage for both presentation content and all software and stored data, both for the memory elements and the communications links between the memory elements and the processing elements of active computer system 400.

Active memory and processing component 400 comprises one or more processors 440, random access memory 415 connected to processors 440, an operating system 461 stored in and using random access memory 415, a permanent multi-tiered memory subsystem 410, a memory resolution component 411 connected to memory subsystem 410 for retrieving and correcting the contents of memory subsystem 410, an energy management program 471 for regulating power coming from photonic radiation 10, a sensor input program 481 for processing user input 482 received by sensor layer 600 sensors, and a display output program 491 for producing presentation content 492 for display via display elements 500. Active computer system 400 receives its power 399 from energy-storage elements 300, regulating use and amount of received energy 299 via energy management program 471 connected to energy-storage components 300, energy-conversion components 200, and in shielded embodiments electrically-activated shield components 150. The multi-tiered memory subsystem 410 uses memory resolution component 411 to retrieve, reconcile, and correct the contents of memory. The output of memory subsystem 410 includes both book content 499 for the users and all programs 411, 461, 471, 481, 491 for operating the embodiments. Permanent memory subsystem 410 comprises a plurality of memory storage elements 412, 413, 414 of different types, and provides correction means for different classes of errors using memory resolution component 411. Permanent memory subsystem 410 contains multiple copies of all data and programs of the embodiments, including memory resolution component program 411, operating system 461, energy management program 471, sensor input program 481, display output program 491, and all presentation content 499. Memory resolution component 411 comprises a simple, robust, reliably-stored, stable program which retrieves requested content from memory storage elements 412, 413, 414, compares and processes retrieved content to detect and correct errors, and passes the corrected content to functional random access memory 415 to be used as program code or as book content 499.

FIG. 13 shows three exemplary types of memory storage elements 412, 413, 414. Not included in the types shown is static-charge memory, because charge leakage degrades such memory content at a rate that renders it unusable for storage over long time periods from decades to centuries. Likewise, magnetic-field-stored memory is excluded. Static read-only semiconductor memory 414 comprises a plurality of semiconductor elements fabricated with their content “hard-coded”, meaning that each binary character stored therein comprises a doped or deposited metal or semiconductor element that degrades at a rate on the order of centuries: a hardware-level memory. Memory 414 is easily integrated with conventional processing, storage, and communications circuit elements, but is more subject to degradation over time than other memory types due to charge migration and loss of the dopant or deposition. Degradation of memory 414 is reduced by increasing element size and mass, but consequently suffers from reduction of storage density. Degradation of memory 414 is also reduced considerably by incorporating one or more forms of forward error-correcting encoding into its stored content.

Optical memory 413 is fabricated, written, and read using one or more of the longest-lifetime optical storage technologies now in conventional development and engineering. The advantages and disadvantages of optical memory 413 resemble those of static-dopant memory 414. An exemplary form of optical memory 413 is a non-volatile all-optical memory fabricated from phase change materials using amorphous alloys that can switch between crystalline and amorphous states (see http://www.gizmag.com/first-all-optical-permanent-on-chip-memory/39523/).

Physical memory 412 comprises an encoding fabricated by engraving, deposition, or other surface-altering process on a metallic surface, at the nanoscale level, of one or more encodings of the desired presentation content and presentation programs. Such encoding requires slower and energy-intensive search, scanning, retrieval, and decoding, but offers one or more forms of redundancy serving the error-detection and error-correction processes of the memory resolution component. Physical memory 412 has the slowest retrieval time of the three subsystems 412, 413, 414, but it offers the most-stable form of storage of the longest time scales.

Other non-volatile memory systems are in development, among them spin-transfer torque magnetic RAM, phase-change memory, metal-oxide resistive RAM, and conductive bridge RAM, each of which manifests a different set of advantages and disadvantages for use in glass book 100. As memory technologies continue to mature, memories other than those disclosed in the present embodiments may be integrated into it.

Memory resolution component 411 treats all memories 412, 413, 414 as sources for the same information, retrieving content in parallel. Element 411 applies any error-detection and error-correction processes appropriate for each type of memory, compares the results, and applies a conventional selection process that eliminates the most-significant errors found, writing the result into functional random access memory 415 for execution as part of a program 461, 471, 481, 491 or for presentation as part of stored book content 499 available to the user.

### Publication and Fabrication Process of the Embodiments

Embodiments are published and fabricated as follows:
1. With respect to the digital content of the embodiments, the digital content to be presented externally for reading and perusal is prepared for storage in the permanent multi-tiered memory subsystem 410 in active computer system 400 according to suitable means such as those afforded by the electronic literary macramé (ELM) process, producing an organized set of digital components to be presented visually. The operating programs for providing reader presentation of digital content are stored in the active computer layer.
2. The organized set of all digital components, including book content 499 to be presented and operating programs 461, 471, 481, 491 and all others required for retrieving and presenting digital content, is tested for correct operation, interaction, and stability.
3. The organized set of all digital components, including both book content 499 and all operating programs, is stored permanently in one or more flat read-only memory elements of permanent multi-tiered memory subsystem 410 in the active computer system 400 of the embodiments.
4. The one or more flat read-only memory elements of the computer system of the embodiments are connected to said computer system in a single flat layer as described hereinabove.
5. The computer system, its memory elements, its display elements, and its sensor elements are all tested to certify acceptable operation of said computer system.
6. Connections 320, 430, 540, 640 described above are fabricated to connect energy-conversion components 200 to the electric-storage components 300, the electric-charge-storage components 300 to the processing and memory component 400, and the processing and memory component 400 to display layer 500 and sensor layer 600.
7. With respect to the physical components, the interior layers, comprising all alternating active and passive layers 200, 250, 300, 350, 400, 450, 500, 600 as described above, are firmly, uniformly, and tightly stacked as described above, and bonded tightly together across their adjoining flat surfaces so as to eliminate the presence of gaps and of any bonding material other than the material of the layers themselves. (Note: U.S. Pat. No. 6,131,410, “Vacuum fusion bonding of glass plates”, teaches one means for accomplishing this step; numerous U.S. patents teach the use of “surface activated bonding” as another means.)
8. Each fully-connected embodiment in all its active and passive layers is tested to certify acceptable operation of the whole embodiment before its final permanent enclosure.
9. The enclosing insulating transparent outer front shell 120 and transparent outer rear shell 110 are fitted tightly around and bonded to all of the interior layers and connections and sealed against all exterior access by other than photonic means to produce sealed outside shell 105 and thus the complete glass book 100. (Again, vacuum fusion bonding or surface activated bonding may be used in this step)

### Presentation Process of the Embodiments

The embodiments are used by a reader as follows:
1. A reader orients the embodiment's exterior rear surface 111 to expose energy-conversion component 200 to a suitable photonic energy source, thereby capturing energy and converting it to electric current.
2. Energy-conversion component 200 provide electric current to energy-storage component 300 to hold converted energy.
3. Energy-storage component 300, on attaining and sustaining a suitable level of charge, supplies electric current to activate processing and memory component 400.
4. Processing and memory component 400 in turn activates display layer 500 and sensor layer 600 to initiate interaction with the reader.

5. The reader triggers the transmission of signals via elements of sensor layer 600 to processing and memory component 400 to select contents of the memory elements to be displayed by display layer 500.
6. Processing and memory component 400 retrieves the reader-specified contents of the memory elements and transmits said contents to display layer 500.
7. Display layer 500 present the contents of the selected memory elements.
8. The reader continues reading via Step 5 or deactivates processing and memory component 400 to return it to its state preceding Step 1.
9. The memory resolution component 411 of processing and memory component 400 operates at all times during active use to insure integrity, accuracy, and functioning of all data and software.

The elements of the embodiments of the invention are fabricated as separate layers. The layers have the same general shape which may be a regular shape including and not limited to a polygon such as a square, rectangle, circle, ellipse, or an irregular shape. In the disclosed embodiments the shape is a quadrilateral such as a square or rectangle. Each layer, except for the external shell layers, has the same length and width but the thickness may vary depending upon the function of the layer and its content elements. For example, the fourth layer has processing and memory components. Those components may all be fabricated on a single substrate and thus form a single system on a substrate or may comprise multiple components assembled and interconnected with one another on a common substrate. If the layer comprises a single substrate, the entire system may be sealed during manufacture by depositing an insulating layer such as silicon dioxide, silicon nitride or a low temperature glass. Other embodiments may have multiple components that are individually packaged and assembled on a substrate or may be assembled on a substrate and then the entire assembly is packaged into a layer. Unpackaged devices that are assembled on a substrate are embedded in a suitable material that hardens into a layer with opposite planar surfaces. In either case, the fourth layer will still have uniform, opposite planar surfaces that are flat and fit against the third and fifth layers, respectively.

In a set of embodiments that may be combined substantially and effectively with one another, the present embodiments incorporates supplemental or alternative memory means for storing, retaining, retrieving, and delivering its presentations. Such memory means in various embodiments may include phased-array optical storage and retrieval, technologies that contain no physically-moving parts at any scale greater than the atomic or nanometric, and other technologies that employ MEMs and other microscale embedded parts not significantly affected functionally by physical, electrical or magnetic forces from outside.

The elements of display layer 500 and their operation and appearance may incorporate color, interference-based perspectives, holography, 3-D display technologies, and degrees of transparency and translucency.

The type of content presented may include images, animations, video, audio, and any other kind of digitally-stored media presentable to a human user.

The reader's inputs to the elements of sensor layer 600 may include touch, gesture, temperature difference, imaging (for camera), electrical signaling, capacitance coupling, or other forms of input. The responsive embodiments encompass responses in forms similar to these input forms as suitable for different conditions of interaction with the reader.

Charge-storage elements 300 may be charged by capture of energy from photovoltaic cells, induction loops, thermoelectric elements, Hall-effect elements, inertial power generators, ionization energy capture elements, and antennas for electromagnetic radiation. Numerous patents teach the specifics of these methods of energy capture.

While the disclosed embodiments comprise flat surfaces, those skilled in the art understand that further embodiments of the invention may be fabricated with curved surfaces. Those skilled in the art are familiar with curved television displays and with curved displays on smartphones. Embodiments of the invention also include curved surfaces. For such embodiments, the relative location of the sequential curved layers comprising components, are the same as the embodiments having flat surfaces. Of course, the curved surfaces will have compatible radii of curvature. The curved layers may have opposite convex and concave surfaces or comprise a planar surface on one side and convex or concave surface on the other side. According, alternate embodiments may have all layers with substantially the same radii or curvature or embodiments that have may have diverse layers including one or more layers with opposite flat surfaces, one or more with concavo/convex surfaces, one or more layers with plano/convex surfaces, or one or more layers with plano/concave surfaces.

The common theme and purpose of this embodiment is the preservation over long time scales of a base of information from which a user can select information elements, without requiring the use of specialized power sources or tools, external means of protection and preservation, special procedures for retrieval and presentation, separation from any device or object for which the information elements are needed, or the need to address other care and access concerns usually inherent in obtaining information for application to specific purposes. In short, if a person happens on the embodiment anywhere there is a decent light source, that person can make use of it.

### APPENDIX

Embodiments of the invention may also be described as:
A. A durable, sealed information presentation apparatus, comprising:

one or more first components (elements) for capturing energy from external sources;

one or more second components for converting energy captured by the one or more first components;

one or more third components for storing energy converted by the one or more second components;

one or more fourth components for storing, retaining, preserving, and accessing permanently-stored information;

one or more fifth components for capturing signals from a human user;

one or more sixth components for retrieving from the one or more fourth components permanently-stored information selected according to the signals captured by the one or more fifth components;

one or more seventh components for presenting to the human user the permanently-stored information retrieved by the one or more sixth components;

one or more eighth components for protecting the one or more first, second, third, fourth, fifth, sixth, and seventh components against damage via radiation; and

one or more ninth components enclosing all of the first, second, third, fourth, fifth, sixth, seventh, and eighth components and sealing them physically for protecting them against damage by physical and chemical means.
B. A device for storing and displaying information comprising:

a shell enclosing a plurality of components disposed inside the shell to protect the enclosed components from external fluids and external impacts that may contact the shell;

said shell having one or more transparent surfaces;

said shell consisting essentially of glass or glass-like material;

said shell having one or more surface portions responsive to external commands for operating the components inside the shell; and

said shell having no openings penetrating its surface in order to seal the components inside the shell from fluids outside the shell;

said components inside the shell comprising:
a converter for converting incident energy into electrical energy;
an electrical energy storage component device coupled to the converter for storing the converted electrical energy;
a memory for holding information;
a display for displaying information stored in the memory; and
a processor coupled to the converter, the energy storage device, the memory and the display for operating the device convert incident energy into electrical energy, store the electrical energy in the electrical storage device, retrieve information from the display and display said information on the display.

While illustrative embodiments have been illustrated and described, it will be appreciated that various changes can be made therein without departing from the spirit and scope of the invention.

The embodiments of the invention in which an exclusive property or privilege is claimed are defined as follows:

1. A durable, sealed information presentation apparatus, comprising:
one or more first components for capturing energy from external sources;
one or more second components for converting energy captured by the one or more first components;
one or more third components for storing energy converted by the one or more second components;
one or more fourth components for storing, retaining, preserving, and accessing permanently-stored information;
one or more fifth components for capturing signals from a human user and relaying them to the one or more fourth components;
one or more sixth components for presenting to the human user the permanently-stored information retrieved from the one or more fifth components;
one or more seventh components for protecting the one or more first, second, third, fourth, fifth, sixth, and seventh components against damage via radiation; and
one or more eighth components enclosing all of the first, second, third, fourth, fifth, sixth, and seventh components and sealing said first-seventh components to protect said first-seventh layers from damage by physical or chemical means.

2. The durable, sealed information presentation apparatus of claim 1 wherein:
the first and second components comprise one or more active, flat energy-conversion elements arranged in uniform planar fashion;
the third components comprise one or more electric-charge-storage elements arranged in single-planar fashion and connected via two or more conductive connections to the one or more flat energy-conversion elements;
the fourth components comprise an active computer system arranged as a flat set of processing and memory elements, connected to the one or more flat electric-charge-storage elements via two or more conductive connections;
the fifth components comprise an active, flat sensor layer of electronic components, connected to the computer system via two or more conductive connections, for rendering signals from external sources accessible to said computer system from a direction opposite to said third flat insulating layer;
the sixth components comprise an active, durable, flat display layer of electronic components substantially coplanar with the active, flat sensor layer connected to the computer system via two or more conductive connections, for rendering signals from the computer system visible for reading from a direction opposite to said third flat insulating layer;
the seventh components comprise each a passive, first flat insulating layer of durable glass-like transparent insulating material placed insulatively and supportively between the one or more first components and the one or more third components, between the one or more third components and the one or more fourth components, or between the one or more fourth components and the one or more fifth components; and
the eighth components comprise outer shells of durable glass-like transparent insulating material tightly enclosing all other elements and components in a durable, permanently-sealed enclosure.

3. The durable, sealed information presentation apparatus of claim 2 wherein the specific sequence of stacked and bonded layers, enclosed by the outer shell of durable glass-like transparent insulating material, comprises:
a first layer of first and second components comprising one or more active, flat energy-conversion elements arranged in uniform planar fashion for converting incident energy into electrical energy;
a second layer of seventh components comprising a passive, first flat insulating layer of durable glass-like transparent insulating material;
a third layer of third components comprising one or more electric-charge-storage elements arranged in single-planar fashion;
a fourth layer of seventh components comprising a passive, first flat insulating layer of durable glass-like transparent insulating material;
a fifth layer of fourth components comprising an active computer system arranged as a flat set of processing and memory elements;
a sixth layer of seventh components comprising a passive, first flat insulating layer of durable glass-like transparent insulating material;
a seventh layer of fifth components comprising an active, flat sensor layer of electronic components; and
an eighth layer of sixth components comprising an active, durable, flat display layer of electronic components substantially coplanar with the seventh layer of fifth components comprising the active, flat sensor layer.

4. The durable, sealed information presentation apparatus of claim 3 wherein the first through eight layers are sequentially boned to each other in the same order as recited in claim 3.

5. The durable, sealed information presentation apparatus of claim 2 in which the specific sequence of stacked and bonded layers, enclosed by the outer shell of durable glass-like transparent insulating material, comprises:
a first layer of first and second components comprising one or more active, flat energy-conversion elements arranged in uniform planar fashion;
a second layer of seventh components comprising a passive, first flat insulating layer of durable glass-like transparent insulating material;
a third layer of third components comprising one or more electric-charge-storage elements arranged in single-planar fashion;
a fourth layer of seventh components comprising a passive, first flat insulating layer of durable glass-like transparent insulating material;
a fifth layer of fourth components comprising an active computer system arranged as a flat set of processing and memory elements;
a sixth layer of seventh components elements a passive, first flat insulating layer of durable glass-like transparent insulating material;
an eight layer of sixth components comprising an active, durable, flat display layer of electronic components arranged in single-planar fashion;
a ninth layer of seventh components a passive, first flat insulating layer of durable glass-like transparent insulating material; and
a tenth layer of fifth components comprising an active, flat sensor layer of electronic components.

6. The durable, sealed information presentation apparatus of claim 2 in which the specific sequence of stacked and bonded layers, enclosed by the outer shell of durable glass-like transparent insulating material, comprises:
a first layer of first and second components comprising one or more active, flat energy-conversion elements arranged in uniform planar fashion;
a second layer of seventh components comprising a passive, first flat insulating layer of durable glass-like transparent insulating material;
a third layer of fourth components comprising an active computer system arranged as a flat set of processing and memory elements;
a fifth layer of seventh components comprising a passive, first flat insulating layer of durable glass-like transparent insulating material;
a sixth layer of third components one or more electric-charge-storage elements arranged in single-planar fashion;
a seventh layer of seventh components comprising a passive, first flat insulating layer of durable glass-like transparent insulating material;
an eighth layer of sixth components comprising an active, durable, flat display layer of electronic components arranged in single-planar fashion;
a ninth layer of seventh components comprising a passive, first flat insulating layer of durable glass-like transparent insulating material; and
a tenth layer of fifth components comprising an active, flat sensor layer of electronic components.

7. The durable, sealed information presentation apparatus of claim 2 in which the specific sequence of stacked and bonded layers, enclosed by the outer shell of durable glass-like transparent insulating material, comprises:
a first layer of first and second components comprising one or more active, flat energy-conversion elements arranged in uniform planar fashion;
a second layer of seventh components comprising a passive, first flat insulating layer of durable glass-like transparent insulating material;
a third layer of fourth components comprising an active computer system arranged as a flat set of processing and memory elements;
a fifth layer of seventh components comprising a passive, first flat insulating layer of durable glass-like transparent insulating material;
a sixth layer of third components comprising one or more electric-charge-storage elements arranged in single-planar fashion;
a seventh layer of seventh components comprising a passive, first flat insulating layer of durable glass-like transparent insulating material;
an eighth layer of first and second components comprising one or more active, flat energy-conversion elements arranged in uniform planar fashion;
a ninth layer of sixth components comprising an active, durable, flat display layer of electronic components arranged in single-planar fashion;
a tenth layer of seventh components comprising a passive, first flat insulating layer of durable glass-like transparent insulating material; and
an eleventh layer of fifth components comprising an active, flat sensor layer of electronic components.

8. The durable, sealed information presentation apparatus of claim 2 wherein at least one of the insulating layers, the energy-conversion elements, the energy-storage elements, the active computer system, the display layer, and the sensor layer is fully opaque across all its dimensions.

9. The durable, sealed information presentation apparatus of claim 2 wherein none of the insulating layers, the energy-conversion elements, the energy-storage elements, the active computer system, the display layer, and the sensor layer is fully opaque across all its dimensions, thereby permitting light to pass from one face of the glass book through to the opposite face and making external background content visible through the display layer.

10. The durable, sealed information presentation apparatus of claim 8 wherein the display layer overlays information from the active computer system on the external background content, thereby combining the information with the external background content.

11. The durable, sealed information presentation apparatus of claim 8 wherein the display layer dims the light originating from the external background content, thereby making information from the active computer system more clearly visible.

12. The durable, sealed information presentation apparatus of claim 2 wherein one or more of the first, third, fourth, fifth, and sixth components incorporates structural material that is durable, insulating, and protective of the component.

13. The durable, sealed information presentation apparatus of claim 2 wherein the active, flat sensor layer comprises a camera for receiving external visual signals.

14. The durable, sealed information presentation apparatus of claim 2 wherein the active, flat sensor layer comprises a touchscreen for receiving tactile cues.

15. The durable, sealed information presentation apparatus of claim 2 wherein the active, flat sensor layer displays prompting information.

16. The durable, sealed information presentation apparatus of claim 2 wherein the outer shell of durable glass-like transparent insulating material comprises a Faraday cage.

17. The durable, sealed information presentation apparatus of claim 2 comprising one or more flat, reactive, externally-facing layers to shield each of the one or more active, flat energy-conversion elements from excessive irradiation.

18. The durable, sealed information presentation apparatus of claim 2 wherein one or more of the one or more seventh components comprise a passive, flat insulating layer of durable glass.

19. The durable, sealed information presentation apparatus of claim 2 wherein one or more of the one or more seventh components comprise a passive, flat insulating layer of durable material selected from the group consisting of silica glasses, fluoride glasses, aluminosilicate glasses, phosphate glasses, chalcogenide glasses, amorphous metals, polymer glasses, and glass ceramics.

20. The durable, sealed information presentation apparatus of claim 2 wherein the one or more fifth components comprise an active, durable, flat sensor layer of electronic components embedded in durable transparent glass.

21. The durable, sealed information presentation apparatus of claim 2 wherein the one or more sixth components comprise an active, durable, flat display layer of electronic components embedded in durable transparent glass.

22. The durable, sealed information presentation apparatus of claim 2 wherein the one or more eighth components comprise a durable glass outer shell.

23. The durable, sealed information presentation apparatus of claim 2 wherein the one or more third components comprise one or more electric-charge-storage elements selected from the group consisting of Zamboni piles, capacitors, electric double-layer capacitors, ultracapacitors, and lithium-ion cells

24. A durable, sealed information presentation apparatus comprising:
one or more active, flat energy-conversion elements arranged in uniform planar fashion;
a passive, first flat insulating layer of durable glass or glass-like transparent insulating material;
one or more electric-charge-storage elements arranged in single-planar fashion and connected via two or more conductive connections to the one or more flat energy-conversion elements;
a passive, second flat insulating layer of durable glass or glass-like transparent insulating material;
an active computer system arranged as a flat set of processing and memory elements, connected to the one or more flat electric-charge-storage elements via two or more conductive connections;
a passive, third flat insulating layer of durable glass or glass-like transparent insulating material;
an active, durable, flat display layer of electronic components connected to the computer system via two or more conductive connections, for rendering signals from the computer system visible for reading from a direction opposite to said third flat insulating layer;
an active, flat sensor layer of electronic components substantially coplanar with the active, flat display layer, connected to the computer system via two or more conductive connections, for rendering signals from external sources accessible to said computer system from a direction opposite to said third flat insulating layer; and
an outer shell of durable glass-like transparent insulating material tightly enclosing all other elements and components in a durable, permanently-sealed enclosure.

25. The durable, sealed information presentation apparatus of claim 24 wherein the energy-conversion elements are selected from the group consisting of photovoltaic cells, induction loops, thermoelectric elements, Hall-effect elements, inertial power generators, ionization energy capture elements, and antennas for electromagnetic radiation.

26. The durable, sealed information presentation apparatus of claim 24 wherein the sensor layer is responsive to signals from external sources are selected from the group consisting of touches, gesture, thermal difference, imaging, electrical-field difference, magnetic-field difference, and capacitance coupling.

27. The durable, sealed information presentation apparatus of claim 24 wherein the signals from the computer system visible for reading incorporate features selected from the group consisting of color, interference-based perspectives, holography, 3-D display technologies, and degrees of transparency and translucency.

28. The durable, sealed information presentation apparatus of claim 24 wherein the electronic components comprise a see-through display for the reader.

29. The durable, sealed information presentation apparatus of claim 24 further comprising a memory resolution component for detecting, correcting, and healing errors in stored and communicated content of the memory and processing elements.

30. A durable, reliable, self-powered, reader-directed digital library glass book, comprising:
a passive, hardened, toughened, flat-surfaced outer rear shell of durable transparent insulating material comprising glass or glass-like material, having an exterior front planar surface and an exterior rear planar surface allowing handling and access by external means, and an interior planar surface;
one or more active, flat photovoltaic elements arranged in uniform planar fashion, having a first planar surface in full contact with the entire interior planar surface of the outer rear shell, and a second planar surface, said photovoltaic elements for converting photonic radiation directed at the first planar surface into electrical current;
a passive, first flat insulating layer of durable transparent insulating material comprising glass or glass-like material having a third planar surface in full contact with the entire second planar surface of the one or more photovoltaic elements, and having a fourth planar surface;
one or more active, flat, durable, electric-charge-storage elements comprising batteries or solid-state capacitors arranged in single-planar fashion with a fifth planar surface in contact with the fourth planar surface of first flat insulating layer of durable glass or glass-like transparent insulating material and a sixth planar surface opposite the fifth planar surface, and connected via two or more conductive connections to the one or more flat photovoltaic elements;
a passive, second flat insulating layer of durable transparent insulating material comprising glass or glass-like material having a seventh planar surface in full contact with the entire sixth planar surface of the one or more flat electric-charge-storage elements, and an eighth planar surface opposite the seventh planar surface;
an active computer system arranged as a flat set of processing and memory elements, having a ninth planar surface and a tenth planar surface opposite the ninth planar surface, connected to the one or more flat electric-charge-storage elements via two or more conductive connections with its ninth planar surface in full contact with the eighth planar surface of the second flat insulating layer of durable glass-like transparent insulating material;
a passive, third flat insulating layer of durable transparent insulating material comprising glass or glass-like material, having an eleventh planar surface in full contact with the entire tenth planar surface of the computer system and a twelfth planar surface opposite the eleventh planar surface;
an active, flat display layer of electronic components connected to the computer system via two or more conductive connections having a thirteenth planar surface in contact with the twelfth planar surface of the third flat insulating layer of durable glass-like transparent insulating material, and having a fourteenth planar surface opposite the thirteenth planar surface, for rendering signals from the computer system visible for reading from a direction opposite to said third flat insulating layer;
an active, flat sensor layer of electronic components substantially coplanar with the active, flat display layer, connected to the computer system via two or more conductive connections and in contact with the twelfth planar surface of the third flat insulating layer of durable glass-like transparent insulating material, for rendering signals from external sources accessible to said computer system from a direction opposite to said third flat insulating layer;
a passive, hardened, toughened, flat-surfaced outer front shell of durable transparent insulating material comprising glass or glass-like material, having an interior planar surface in contact with the fourteenth planar surface of the active, flat display layer, and an exterior front planar surface and an exterior rear planar surface allowing handling and access by external means; and
a thin, passive, toughened, seamless layer of durable transparent insulating material comprising glass or glass-like material bonding the outer rear shell and the outer front shell and sealing all other elements of the invention permanently between the outer rear shell and the outer front shell, thereby providing protection of above said active layers from physical, chemical, electrical, and thermal damage.

31. A method for producing a durable, reliable, self-powered, reader-directed digital library glass book, comprising the steps of:
preparing and storing the digital content to be presented externally for reading and perusal in a digital memory device, producing an organized set of digital components to be presented visually;
storing operating programs for retrieving digital content for presentation on a display;
storing permanently in a read-only digital memory the organized set of all digital components;
connecting the read-only digital memory to a computer system fabricated in a single flat layer;
connecting the computer system to a set of display elements fabricated in a single flat layer;
connecting the computer system to a set of sensor elements fabricated in a single flat layer;
stacking in sequential order a layer comprising a flat set of energy-conversion elements, a flat insulating layer, a layer comprising a flat set of electric-charge-storage elements, a flat insulating layer, a flat layer containing the computer system and the digital memory elements, a flat insulating layer, a flat layer of display elements, and a flat layer of sensor elements;
installing connections from the energy-conversion elements to the electric-charge-storage elements, from the electric-charge-storage elements to the computer system, and from the computer system to the display layer and the sensor layer;
bonding all the layers tightly together across their adjoining flat surfaces so as to eliminate the presence of gaps and of any bonding material other than the material of the layers themselves;
fitting enclosing insulating outer front and outer rear shells tightly around and bonded to all of the interior layers and connections; and
sealing the outer front and rear shells against all exterior access by other than functional means.
